(19) United States
(12) Patent Application Publication
(10) Pub. No.: US 2026/0175425 A1
(43) Pub. Date: Jun. 25, 2026

(54) ELECTRONIC DEVICE AND METHOD OF PLANNING MOVING PATH OF ROBOT

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Jun-Won JANG, Suwon-si (KR); Jaeheung PARK, Seoul (KR); Suhyun JEON, Seoul (KR); Minsoo KIM, Seoul (KR); Minsu CHANG, Suwon-si (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/249,393

(22) Filed: Jun. 25, 2025

(30) Foreign Application Priority Data
Dec. 19, 2024 (KR) 10-2024-0191277

(51) Int. Cl. B25J 9/16; G05D 1/229; G05D 1/246; G05D 101/15

(52) U.S. Cl. CPC B25J 9/1664; G05D 1/229; G05D 1/2464; G05D 2101/15

(57) ABSTRACT

An electronic device, including: a processor; and a memory configured to store instructions which, when executed individually or collectively by the processor, cause the electronic device to: form a configuration space including a starting point, a target point, and map information for generating a moving path of a robot; predict, based on the configuration space, a current position of the robot, and a progress corresponding to the current position with respect to the moving path; obtain a sample corresponding to an arbitrary point in a portion the configuration space, based on the progress; and generate the moving path by expanding a tree until the tree reaches the target point from the current position, by adding the sample to the tree, wherein the tree represents a hierarchical data structure for generating the moving path

### CROSS-REFERENCE TO RELATED APPLICATION

This application is based on and claims priority under 35 U.S.C. § 119 to Korean Patent Application No. 10-2024-0191277, filed on Dec. 19, 2024, in the Korean Intellectual Property Office, the disclosure of which is incorporated by reference herein in its entirety.

### BACKGROUND

### 1. Field

The disclosure relates to an electronic device and a method for planning a moving path of a robot.

### 2. Description of the Related Art

Generally, a mechanical device that performs a movement similar to a movement of the human by using electrical or magnetic action may be referred to as a robot. Robots may perform tasks that were previously performed by humans instead of humans, thereby increasing the efficiency of the tasks. In order for a robot to perform a particular task (e.g., a task of grabbing or grasping an object), a moving path of the robot may be generated from an initial position (e.g., a starting point) before performing the task to a final position (e.g., a target point) at which the task may be performed. One of sampling-based path planning processes that may be used to plan a path connecting the starting point to the target point is a rapidly-exploring random tree (RRT) algorithm.

The RRT algorithm may use randomly-sampled samples from a configuration space (C-space) in which the robot performs a task. For example, according to the RRT algorithm, a sample may be extracted by randomly selecting an arbitrary point from the entire configuration space, and a path to the target point may be found by starting from the starting point and expanding a tree toward the randomly selected sample.

The above information may be provided as related art for the purpose of helping to understand the present disclosure. No claim or determination is made as to whether any of the above contents can be applied as prior art related to the present disclosure.

### SUMMARY

One or more embodiments may address at least the above problems and/or disadvantages and other disadvantages not described above. Also, the embodiments are not required to overcome the disadvantages described above, and an embodiment may not overcome any of the problems described above.

In accordance with an aspect of the disclosure, an electronic device includes: a processor; and a memory configured to store instructions which, when executed individually or collectively by the processor, cause the electronic device to: form a configuration space including a starting point, a target point, and map information for generating a moving path of a robot; predict, based on the configuration space, a current position of the robot, and a progress corresponding to the current position with respect to the moving path; obtain a sample corresponding to an arbitrary point in a portion the configuration space, based on the progress; and generate the moving path by expanding a tree until the tree reaches the target point from the current position, by adding the sample to the tree, wherein the tree represents a hierarchical data structure for generating the moving path.

The starting point may include a shape at a starting position in the configuration space before the robot performs a motion.

The target point may include a shape at a target position in the configuration space at which the robot performs a task.

The instructions, when executed individually or collectively by the processor, may further cause the electronic device to: predict the progress using a neural network based on the configuration space and the current position.

The tree may include a rapidly-exploring random tree (RRT), and
wherein the instructions, when executed individually or collectively by the processor, may further cause the electronic device to: determine the progress by comparing the current position with a point included in the moving path.

The instructions, when executed individually or collectively by the processor, may further cause the electronic device to: determine, based on the progress, an area including a predicted next position is in the configuration space; and generate the sample by uniformly sampling a point included in the area.

The instructions, when executed individually or collectively by the processor, may further cause the electronic device to: based on a constraint being added to the configuration space, generate the sample by sampling a point that satisfies the constraint.

The instructions, when executed individually or collectively by the processor, may further cause the electronic device to: add noise to the sample to obtain a noisy sample; and add the noisy sample to the tree.

In accordance with an aspect of the disclosure, an operating method of an electronic device includes: forming a configuration space including a starting point, a target point, and map information for generating a moving path of a robot; predicting, based on the configuration space a current position of the robot, a progress corresponding to the current position with respect to the moving path; obtaining a sample corresponding to an arbitrary point in a portion of area in the configuration space, based on the progress; and generating the moving path by expanding a tree until the tree reaches the target point from the current position, by adding the sample to the tree, wherein the tree represents a hierarchical data structure for generating the moving path.

The starting point may include a shape at a starting position in the configuration space before the robot performs a motion.

The target point may include a shape at a target position in the configuration space at which the robot performs a task.

The predicting of the progress of the current position may include: predicting the progress using a neural network based on the configuration space and the current position.

The tree may include a rapidly-exploring random tree (RRT), and the predicting of the progress may include: determining the progress by comparing the current position with a point included in the moving path.

The obtaining of the sample may include: determining, based on the progress, an area including a predicted next position in the configuration space; and generating the sample by uniformly sampling a point included in the area.

The obtaining of the sample may include: based on a constraint being added the configuration space, generating the sample by sampling a point that satisfies the constraint.

The generating of the moving path may include: adding noise to the sample to obtain a noisy sample; and adding the noisy sample to the tree.

Additional aspects of embodiments will be set forth in part in the description which follows and, in part, will be apparent from the description, or may be learned by practice of the disclosure.

### BRIEF DESCRIPTION OF THE DRAWINGS

The above and/or other aspects will be more apparent by describing certain embodiments with reference to the accompanying drawings, in which:

FIG. 1 is a diagram illustrating a path planning system for planning a robot moving path, according to an embodiment;

FIG. 2A is a diagram illustrating a deep learning operation process using an artificial neural network (ANN);

FIG. 2B is a diagram illustrating a training and inference process of an ANN model, according to an embodiment;

FIG. 3 is a diagram illustrating a framework for robot moving path generation according to an embodiment;

FIG. 4 is a diagram illustrating a training process of a sampling distribution estimation model, according to an embodiment;

FIG. 5 is a diagram illustrating an inference process of a sampling distribution estimation model, according to an embodiment;

FIG. 6 is a diagram illustrating a training process of a progress predictor, according to an embodiment;

FIG. 7 is a diagram illustrating an inference process of a progress predictor, according to an embodiment;

FIG. 8 is a diagram illustrating an operation of determining a progress of a current position, according to an embodiment;

FIG. 9 is a flowchart illustrating a process for planning a moving path of a robot, according to an embodiment;

FIG. 10 is a diagram illustrating an operation of planning a moving path of a robot, according to an embodiment; and

FIG. 11 is a diagram illustrating an electronic device according to an embodiment.

### DETAILED DESCRIPTION

The following structural or functional description of examples is provided as an example only and various alterations and modifications may be made to the examples without departing from the scope of the disclosure. Thus, an actual form of implementation is not construed as limited to the examples described herein, and should be understood to include all changes, equivalents, and replacements within the idea and the technical scope of the disclosure.

Although terms such as first, second, and the like are used to describe various components, the components are not limited to these terms. Instead, these terms are used only to distinguish one component from another component. For example, a “first” component may be referred to as a “second” component, and similarly, the “second” component may also be referred to as the “first” component.

It should be noted that when a first component is described as being “connected,” “coupled,” or “joined” to a second component, the first component may be directly “connected”, “coupled”, or “joined” to the second component, or a third component may be “connected,” “coupled,” or “joined” between the first and second components.

The singular forms “a,” “an,” and “the” are intended to include the plural forms as well, unless the context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. As used herein, expressions such as “at least one of,” when preceding a list of elements, modify the entire list of elements and do not modify the individual elements of the list. For example, the expression, “at least one of A, B, and C,” should be understood as including only A, only B, only C, both A and B, both A and C, both B and C, or all of A, B, and C. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, examples are described in detail with reference to the accompanying drawings. When describing examples with reference to the accompanying drawings, like reference numerals refer to like components and a repeated description related thereto may be omitted.

FIG. 1 is a diagram illustrating a path planning system for planning a robot moving path, according to an embodiment.

Referring to FIG. 1, according to an embodiment, a path planning system 100 for planning a robot moving path may include at least one of a robot 110 and an electronic device 130. Although FIG. 1 illustrates an example in which the electronic device 130 is separate from the robot 110, embodiments are not limited thereto. For example, in some embodiments the electronic device 130 may be included in the robot 110, or the robot 110 and the electronic device 130 may both be include in another electronic device.

According to an embodiment, the robot 110 may be a device that automatically performs a task or operation, and may be utilized to replace or assist humans in various fields. The robot 110 may be implemented in various forms, including at least one of a humanoid robot, a mobile robot, an industrial robot, and a surgical robot, depending on an intended use and characteristics.

According to an embodiment, technology for controlling a motion (or an operation) of the robot 110 may be required in order for the robot 110 to perform a particular task. For example, in order for the robot 110 to perform a task, a moving path along which the robot 110 needs to move may be planned.

According to an embodiment, the electronic device 130 may plan a path (e.g., a moving path) along which the robot 110 may move from a starting point to a target point to perform a determined task in a work environment.

According to an embodiment, the electronic device 130 may form a configuration space regarding the work environment to generate a moving path of the robot 110. The electronic device 130 may form a configuration space including a starting point, a target point, and map information.

According to an embodiment, the starting point may be a shape formed in the configuration space at a starting position before the robot 110 performs a movement or a motion. The starting point may include a starting position and position information of the robot 110 at the starting position. According to an embodiment, the starting point may be referred to as starting information.

According to an embodiment, the target point may be a shape formed in the configuration space at a target position toward which the robot 110 may perform a motion, and at which the robot may perform a task. In some embodiments, the target position may be (or may correspond to or indicate) an intended position of the robot after the movement or the motion is performed by the robot, and may be (or may correspond to or indicate) a position that allows the robot to perform the task. As an example, if the task includes grabbing or grasping an object, the target position may be a position at which the robot may perform a grasping operation (e.g., activating or actuating an end effector or clamping mechanism) to effectively grasp the object. The target point may include the target position and position information of the robot 110 at the target position. According to an embodiment, the target point may be referred to as arrival information, end information, or target point arrival information. According to embodiments, each of the starting point and the target point may be referred to as an endpoint of the moving path.

According to an embodiment, the map information may include a grid map. The grid map may correspond to a work environment of the robot 110. For example, the grid map may include a free space and an occupied space, in which each grid location or grid point may have a value between a value of zero (“0”) and a value of one (“1”), and a moving path may be generated. The occupied space may be a space in which a moving path may not be generated due to factors such as obstacles in the work environment.

According to an embodiment, the electronic device 130 may generate a moving path leading from a starting point to a target point by sampling an arbitrary point in the configuration space. The electronic device 130 may use a tree, which may refer to a hierarchical data structure for generating a moving path. The tree may be a tree configured with the starting point as a root node and the target point as a leaf node. The electronic device 130 may expand the tree to generate a moving path. The tree may include a plurality of moving paths. For example, the electronic device 130 may obtain (or extract) a sample corresponding to an arbitrary point included in a particular environment (e.g., configuration space). The electronic device 130 may add the obtained sample to the tree. The electronic device 130 may generate a moving path by expanding the tree by sampling and/or adding samples to the tree until obtained samples reach the target point.

According to an embodiment, in some implementations of an RRT algorithm, sampling may be performed on an entire configuration space. The RRT algorithm may have an advantage of being robust to high-dimensional and multi-constrained path generation issues. However, the RRT algorithm may perform sampling on the entire configuration space, and thus may encounter issues such as slow convergence rate, large memory requirements, and path generation delay in narrow passages.

According to an embodiment, the electronic device 130 may perform sampling in a portion of the configuration space, based on the progress corresponding to the current position of the robot 110. According to embodiments, the progress corresponding to the current position may refer to a current progress of the robot 110 with respect to the moving path. For example, progress corresponding to the current position may indicate how far the robot 110 has progressed along the moving path based on the current position of the robot 110. For example, the progress corresponding to the current position may indicate an amount of the moving path that has been completed or traversed by the robot 110 that is located at the current position. The progress may also be referred to as a step. The electronic device 130 may, instead of performing sampling for the entire configuration space, determine an area in which a next position is likely to exist (e.g., an area in which a next position is predicted to exist according to the progress), based on the progress corresponding to the current position, and perform sampling in the corresponding area. According to embodiments, the next position may be referred to as a predicted next position, and the area in which the next position is likely to exist (or predicted to exist) may be referred to as an area including the predicted next position.

For example, when the progress of the current position of the robot 110 is close to 0%, the area in which the next position is likely to exist (e.g., the area including the predicted next position) may be an area oriented toward the starting point rather than the target point (e.g., an area that is closer to the starting point than to the target point). When the progress corresponding to the current position of the robot 110 is close to 50%, the area in which the next position is likely to exist (e.g., the area including the predicted next position) may be an area oriented between the target point and the starting point (e.g., an area that is substantially equidistant to the starting point and to the target point). When the progress corresponding to the current position of the robot 110 is close to 100%, the area in which the next position is likely to exist (e.g., the area including the predicted next position) may be an area oriented toward the target point rather than the starting point (e.g., an area that is closer to the target point than to the starting point).

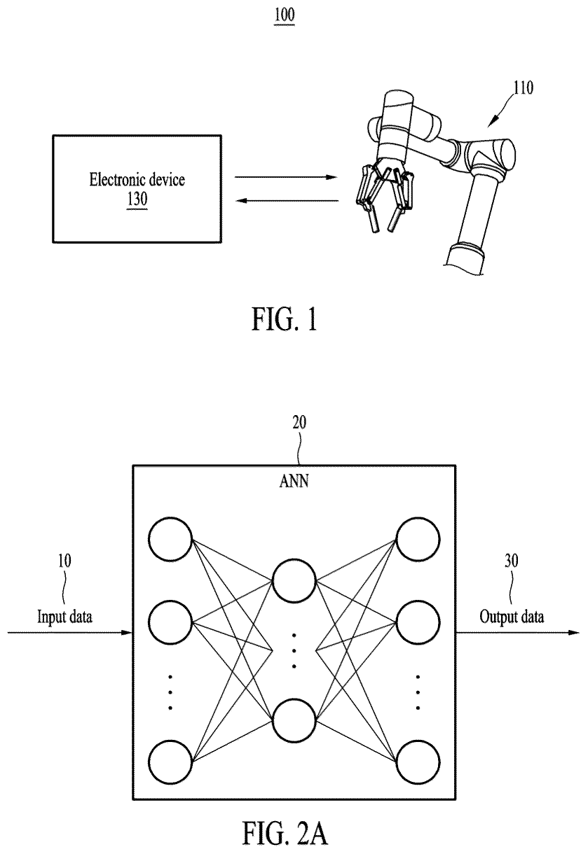

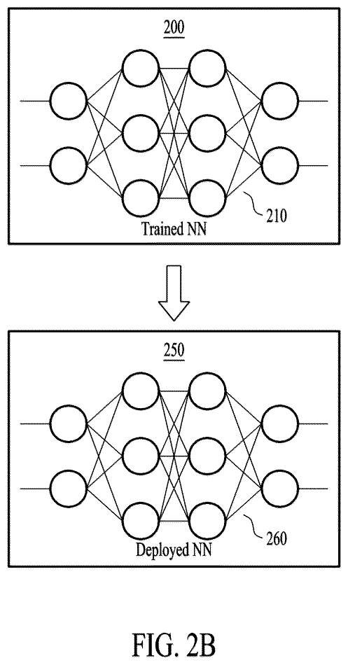

According to an embodiment, the area in which the next position is likely to exist (e.g., the area including the predicted next position) may be repeatedly calculated from the starting point to the target point depending on the position of the robot 110. A set of areas in which the next position is likely to exist may be referred to as a sampling distribution for searching for an optimal moving path. An artificial intelligence (AI) algorithm may be used to obtain the sampling distribution for searching for an optimal moving path. An example of an AI algorithm is described below with reference to FIGS. 2A and 2B.

FIG. 2A is a diagram illustrating a deep learning operation process using an artificial neural network (ANN).

An AI algorithm including deep learning and the like may including inputting input data 10 to (e.g., providing input data 10 as input to) an ANN, and obtaining output data 30 through an operation such as convolution. An ANN may represent a computer science architecture that models a biological brain. In an ANN, nodes corresponding to neurons of the brain may be connected to each other, and may operate collectively to process input data. Examples of various types of neural networks include, but are not limited to, a convolutional neural network (CNN), a recurrent neural network (RNN), a deep belief network (DBN), and a restricted Boltzmann machine (RBM). In a feed-forward neural network, neurons in the neural network have links with other neurons. Such links may extend in one direction, for example, in a forward direction, through the neural network.

Referring to FIG. 2A, a structure is illustrated in which the input data 10 is input to an ANN 20, and the output data 30 is output by the ANN 20. As an example, ANN 20 may be a deep neural network (DNN) including one or more layers. For example, the ANN 20 may be a CNN including one or more layers.

The ANN 20 may be used to extract “features,” such as a border, a line color, and the like, from the input data 10. The ANN 20 may include a plurality of layers. Each of the layers may receive data, process data input to a corresponding layer, and generate data that is to be output from the corresponding layer. The data output from the layer may be a feature map generated by performing a convolution operation of an image or a feature map that is input to the ANN 20 with weight values of at least one filter. Initial layers of the ANN 20 may operate to extract relatively low-level features, such as edges or gradients, from an input. Subsequent layers of the ANN 20 may gradually extract more complex features (e.g., relatively high-level features) such as the eyes and nose in an image.

FIG. 2B is a diagram illustrating a training and inference process for an ANN model, according to an embodiment.

Referring to FIG. 2B, a path planning system for planning a robot moving path (e.g., the path planning system 100 of FIG. 1), according to an embodiment, may include a training device 200 and an inference device 250. The training device 200 may correspond to a computing device having various processing functions such as at least one of generating a neural network, training (or learning) a neural network, and retraining a neural network. For example, the training device 200 may be implemented as, or included in, various types of devices, for example at least one of a personal computer (PC), a server device, a mobile device, and the like.

The training device 200 may generate at least one trained neural network 210 by repetitively training (or learning) a particular initial neural network. The generating of the at least one trained neural network 210 may include determining neural network parameters. The neural network parameters may include various types of data, for example, input/output activations, weights, and biases of a neural network that are input to and output from the neural network. When the neural network is repeatedly trained (e.g., after multiple training iterations are performed), the parameters of the neural network may be tuned to calculate a more accurate output for a particular input.

The training device 200 may transmit the at least one trained neural network 210 to the inference device 250. The inference device 250 may be, for example, a mobile device or an embedded device. The inference device 250 may be dedicated hardware for driving a neural network and may be an electronic device including at least one of a processor, memory, an input/output (I/O) interface, a display, a communication interface, and a sensor.

The inference device 250 may be any digital device that includes a memory element and a microprocessor and has an operational capability, such as at least one of a smartphone, a PC (e.g., a notebook computer), a tablet PC, an AI speaker, a smart TV, a mobile phone, a navigation, a web pad, a personal digital assistant (PDA), a workstation, and the like.

The inference device 250 may drive (e.g., operate or execute) the at least one trained neural network 210 without a change thereto, or may drive a neural network 260 obtained by processing (for example, quantizing) the at least one trained neural network 210. The inference device 250 for driving the neural network 260 may be implemented in a separate device, independent of the training device 200. However, embodiments are not limited thereto. The inference device 250 may also be implemented in the same device as the training device 200. For example, at least one of the training device 200 and the inference device 250 may be implemented as an electronic device (e.g., the electronic device 130 of FIG. 1). For example, the operations of the training device 200 and/or the inference device 250 described below may also be performed by the electronic device 130.

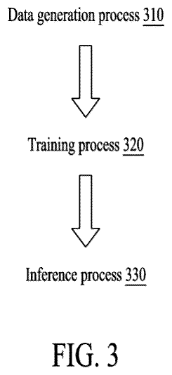

FIG. 3 is a diagram illustrating a framework for robot moving path generation, according to an embodiment.

Referring to FIG. 3, according to an embodiment, the framework for robot moving path generation may include a data generation process 310, a training process 320, and an inference process 330.

The data generation process 310 may be, or may include, a process for generating training data required in the training process 320. The data generation process 310 may be performed by a data generation device. The data generation device may be a training device 200 or a separate device. For example, the data generation process 310 may be performed by a separate device, and the training device 200 may receive training data generated through the data generation process 310 and perform training.

According to an embodiment, the data generation device may generate (or collect) a training data set for training an artificial neural network model (e.g., a sampling distribution estimation model). The training data set may include at least one of information (e.g., a map of a work environment and/or information about obstacles in the work environment) about a work environment (e.g., an environment in which a robot (e.g., the robot 110 of FIG. 1) performs a particular task), a starting point (e.g., a starting position of the robot 110 and/or a posture of the robot 110 at the starting position), a target point (e.g., a target position of the robot 110 and/or a posture of the robot 110 at the target position), a current position of the robot 110, a generated moving path, and a progress corresponding to each position of the robot 110.

In the training process 320, the training device 200 may train an artificial neural network model (e.g., a sampling distribution estimation model and/or the neural network 210 of FIG. 2B) in order to generate a sampling distribution for searching for an optimal moving path.

In the inference process 330, the inference device 250 may use a trained artificial neural network model (e.g., a trained sampling distribution estimation model, the neural network 210, and/or a neural network 260 of FIG. 2B) to generate a sampling distribution for searching for an optimal moving path.

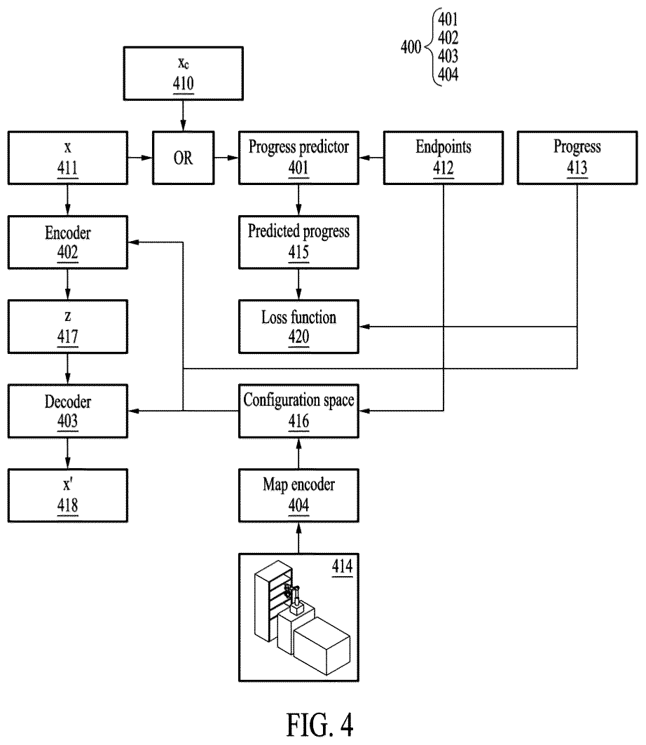

FIG. 4 is a diagram illustrating a training process of a sampling distribution estimation model, according to an embodiment.

Referring to FIG. 4, a training process may correspond to the training process 320 of FIG. 3, and may be performed by a training device that may correspond to at least one of the training device 200 of FIG. 2B and the electronic device 130 of FIG. 1. For example, the training device 200 may train a sampling distribution estimation model 400 using a training data set generated by a data generation device. The training data set may include a real value corresponding to a moving path. The training data set may include a sample x 411 (e.g., corresponding to a next position) regarding the real value, endpoints 412 (e.g., at least one of a starting point and a target point), a progress 413, and map information 414.

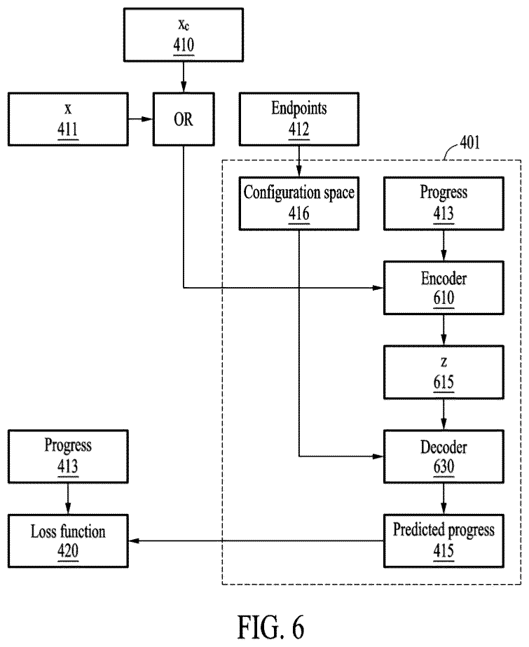

According to an embodiment, the sampling distribution estimation model 400 may include at least one of a progress predictor 401 (which may be referred to as a step predictor), an encoder 402, a decoder 403, and a map encoder 404. According to an embodiment, the training device 200 may predict a progress according to a current position xc 410 of the robot (e.g., the robot 110 of FIG. 1) based on the current position xc 410, the endpoints 412 using the progress predictor 401. Here, the training device 200 may input the sample x 411 to the progress predictor 401 instead of the current position xc 410. The training device 200 may calculate a loss function 420 based on a predicted progress 415 predicted by the progress predictor 401 and the actual value of the progress (e.g., the progress 413) included in the training data set. The training device 200 may train the progress predictor 401 (e.g., modify parameters of the progress predictor 401) so that the loss function 420 may be minimized. When the training of the progress predictor 401 is completed, a difference between the predicted progress 415 predicted by the progress predictor 401 and an actual value (e.g., the progress 413) may converge to a value of zero (“0”). An example of the training of the progress predictor 401 is described in detail with reference to FIG. 6.

According to an embodiment, the progress 413 may be obtained as follows. As an example, the training device 200 may obtain the progress 413 by checking an order of the current sample (e.g., the sample x 411) in the path obtained using the data generation process 310 of FIG. 3. As another example, the training device 200 may calculate the progress 413 by using Equation 1. As another example, the training device 200 may also calculate the progress 413 using a weighted sum of a plurality of functions. The training device 200 may set a first function (e.g., f(x)=|starting point−current position|) and a second function (e.g., g(x)=|target point−current position|), apply a weight to the first function and the second function, and calculate the progress 413 based on a sum of the first function and the second function to which the weight is applied. As another example, the progress 413 may be calculated according to Equation 1 below:

$$s = max ( 0 , 1 - \frac{\vert Goal - xc \vert}{\vert Goal - Start \vert} ) \qquad [ Equation 1 ]$$

In Equation 1, s may denote the progress 413, Goal may denote a target point, Start may denote a starting point, and xc may denote a current position of the robot 110.

According to an embodiment, the training device 200 may compress the map information 414 using the map encoder 404. The map information 414 may include a grid map as described above. The grid map may correspond to the working environment of the robot 110. The map information 414 compressed using the map encoder 404 may be included in a configuration space 416.

According to an embodiment, the training device 200 may form the configuration space 416 including endpoints 412, the progress 413, and the map information 414 that has been compressed. The configuration space 416 may be a dynamic space (e.g., a working environment of the robot 110) in which the robot 110 may perform a task. The endpoints 412 may be formed in the configuration space 416. In the configuration space 416, a shape at a starting position before the robot 110 performs a motion may be formed, and a shape at a target position, toward which the robot 110 may perform the motion, may be formed. In addition, elements such as obstacles within the work environment of the robot 110 may be formed in the configuration space 416.

According to an embodiment, the training device 200 may compress the configuration space 416 and the sample x 411 using the encoder 402 to generate a latent variable z 417. The latent variable z 417 may be in the form of a vector in which the configuration space 416 and the sample x 411 are compressed.

According to an embodiment, the training device 200 may predict a sample x′ 418 by restoring the latent variable z 417 and the configuration space 416 through the decoder 403. The training device 200 may train the encoder 402 and/or the decoder 403 so that a difference between the predicted sample x′ 418 and the actual value, the sample x 411, may be minimized. When the training of the encoder 402 and/or the decoder 403 is completed, the difference between the predicted sample x′ 418 and the actual value (e.g., the sample x 411), may converge to a value of zero “0”.

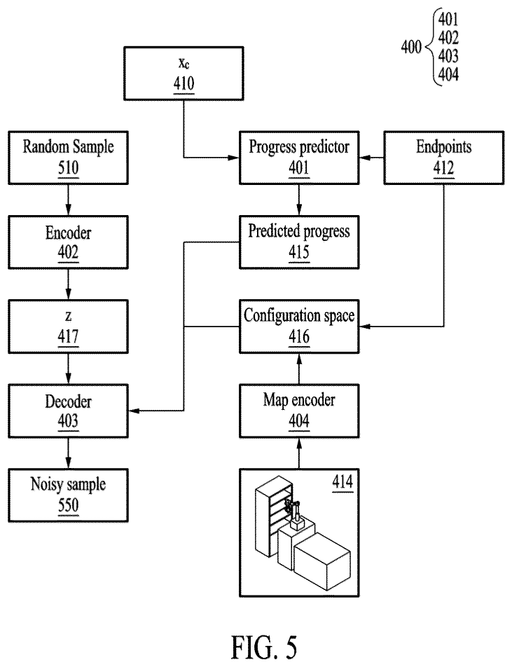

FIG. 5 is a diagram illustrating an inference process of a sampling distribution estimation model, according to an embodiment.

Referring to FIG. 5, an inference process may correspond to the inference process 330 illustrated FIG. 3, and may be performed by an inference device that may correspond to at least one of the inference device 250 of FIG. 2B and the electronic device 130 of FIG. 1. The inference device 250 may obtain at least one of the current position xc 410, the map information 414, and the endpoints 412 of a robot (e.g., the robot 110 of FIG. 1). For example, the inference device 250 may obtain, based on a user input, at least one of the current position xc 410, the map information 414, and the endpoints 412 of the robot 110.

According to an embodiment, the sampling distribution estimation model 400 may be or may include a neural network model that has been trained through the training process described with reference to FIG. 4.

According to an embodiment, the starting point starting point may be a shape formed in the configuration space at a starting position before the robot (e.g., the robot 110 of FIG. 1) performs a motion. The starting point may include a starting position and position information of the robot 110 at the starting position. According to an embodiment, the starting point may be referred to as starting information.

According to an embodiment, the target point may be a shape formed in the configuration space at a target position toward which the robot 110 may perform a motion. For example, the target position may be a position at which the robot 110 may perform a task, or may perform an operation corresponding to the task. The target point may include the target position and position information of the robot 110 at the target position. According to an embodiment, the target point may be referred to as arrival information, end information, or target point arrival information.

According to one embodiment, the map information may include a grid map. The grid map may correspond to the work environment of the robot 110. For example, the grid map may be include a free space and an occupied space, in which each grid location or point may have a value between a value of zero (“0”) and a value of one (“1”) and a moving path may be generated. The occupied space may be a space in which a moving path may not be generated (e.g., may be prevented or constrained from being generated) due to factors such as obstacles in the work environment.

According to an embodiment, the inference device 250 may perform sampling for generating a moving path of the robot 110 by driving the sampling distribution estimation model 400 that has been trained.

According to an embodiment, the inference device 250 may form the configuration space 416 including the map information 414, the endpoints 412 to generate a moving path of the robot 110. The inference device 250 may compress the map information 414 using the map encoder 404 to reduce a data size of the map information 414. The inference device 250 may form the configuration space 416 including the map information 414 that has been compressed, and the endpoints 412.

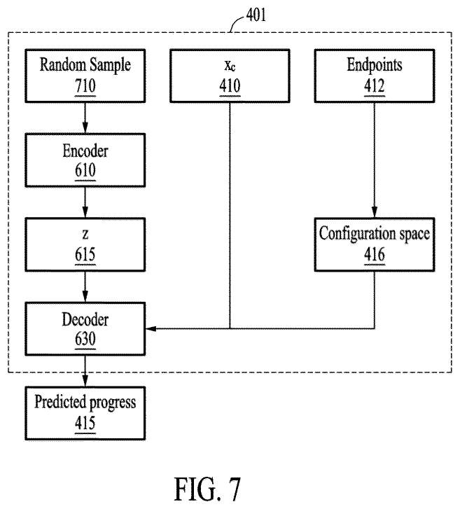

According to an embodiment, the inference device 250 may predict the progress corresponding to the current position xc 410 based on the current position xc 410 and the endpoints 412 of the robot 110 using a neural network (e.g., the progress predictor 401). The inference device 250 may input the current position xc 410 and the endpoints 412 of the robot 110 to the progress predictor 401 to obtain the predicted progress 415. An example of an inference process of the progress predictor 401 is described in detail with reference to FIG. 7.

According to an embodiment, the inference device 250 may compress a random sample 510 using the encoder 402 to generate the latent variable z 417. The inference device 250 may predict a sample x′ corresponding to an arbitrary point in a portion of area of the configuration space 416 based on the latent variable z 417, the configuration space 416, and the predicted progress 415. For example, the inference device 250 may determine, based on the predicted progress 415, an area in which a next position is predicted to exist (e.g., an area including a predicted next position) according to the predicted progress 415 in the configuration space 416. The inference device 250 may uniformly sample points included in the area in which the next position is predicted to exist, thereby generating (or extracting) the sample x′. The sample x′ may be a point corresponding to the next position of the current position xc 410.

According to an embodiment, when a constraint in the configuration space 416 is added, the inference device 250 may sample points that satisfy the constraint to generate the sample x′. For example, the inference device 250 may sample, among points included in the area in which the next position is predicted to exist, only the points that satisfy the constraint. According to embodiments, the constraints may correspond to factors such as obstacles in the work environment, or to other factors such as an overall size of the movement path, a size of each step in the movement path, an overall time corresponding to the movement path, a time corresponding to each step in the movement path, a movement capability of the robot 110, or any other factor, but embodiments are not limited thereto.

According to an embodiment, the inference device 250 may add noise to the sample x′. The inference device 250 may add a noisy sample 550, to which the noise is added, to the tree.

FIG. 6 is a diagram illustrating a training process of a progress predictor, according to an embodiment.

Referring to FIG. 6, a training process may correspond to the training process 320 of FIG. 3, and may be performed by a training device that may correspond to at least one of the training device 200 of FIG. 2B and the electronic device 130 of FIG. 1. For example, the training device 200 may train a sampling distribution estimation model (e.g., the sampling distribution estimation model 400 of FIG. 4) using a training data set generated by a data generation device. Because the sampling distribution estimation model 400 may include the progress predictor 401, an example of a process for training the progress predictor 401 by using the training device 200 is described in detail below.

According to an embodiment, the training data set may include a sample x 411 (e.g., corresponding to a next position) regarding an actual value, the endpoints 412, the progress 413, and the map information 414.

According to an embodiment, the progress predictor 401 may include at least one of an encoder 610 and a decoder 630.

According to an embodiment, the training device 200 may form the configuration space 416 including the endpoints 412. According to an embodiment, the configuration space 416 may also include the map information 414.

According to an embodiment, the training device 200 may compress one of the current position xc 410 of the robot 110 or the sample x 411, and the progress 413, using the encoder 610 to generate a latent variable z 615.

According to an embodiment, the training device 200 may predict a progress corresponding to the current position xc 410 of the robot 110 by restoring the latent variable z 615, the configuration space 416, and position information (e.g., the current position xc 410 or the sample x 411 of the robot 110) used to generate the latent variable z 615 using the decoder 630.

According to an embodiment, the training device 200 may calculate the loss function 420, based on a difference between the predicted progress 415 predicted by the progress predictor 401 and an actual value (e.g., the progress 413). The training device 200 may train at least one of the encoder 610 and the decoder 630 so that the loss function 420 may be minimized. When the training of the at least one of the encoder 610 and the decoder 630 is completed, the difference between the predicted progress 415 predicted by the progress predictor 401 and the actual value (e.g., the progress 413) may converge to a value of zero “0.”

FIG. 7 is a diagram illustrating an inference process of a progress predictor, according to an embodiment.

Referring to FIG. 7, an inference process may correspond to the inference process 330 of FIG. 3, and may be performed by an inference device that may correspond to at least one of the inference device 250 of FIG. 2B and the electronic device 130 of FIG. 1. The inference device 250 may obtain at least one of the current position xc 410, the map information 414, and the endpoints 412 of a robot (e.g., the robot 110 of FIG. 1). For example, the inference device 250 may obtain, based on a user input, at least one of the current position xc 410, the map information 414, and the endpoints 412 of the robot 110.

According to an embodiment, the progress predictor 401 may be or may include a neural network model that has been trained according to the training process described with reference to FIG. 6. For example, each of the encoder 610 and/or the decoder 630 may be or may include a neural network model that has been trained according to the training process described with reference to FIG. 6.

According to an embodiment, the inference device 250 may input the endpoints 412 and the current position xc 410 of the robot 110 to the progress predictor 401 to predict the progress corresponding to the current position xc 410 of the robot 110.

According to an embodiment, the inference device 250 may generate the configuration space 416 including the endpoints 412. Here, the configuration space 416 may include the map information 414, but embodiments are not limited thereto, and in some embodiments the map information 414 may not be included when predicting the progress.

According to an embodiment, the inference device 250 may compress a random sample 710 using the encoder 610 to generate the latent variable z 615. The inference device 250 may, based on the latent variable z 615, the current position xc 410 of the robot 110, and the configuration space 416, predict the predicted progress 415 of the current position xc 410 of the robot 110 using the decoder 630.

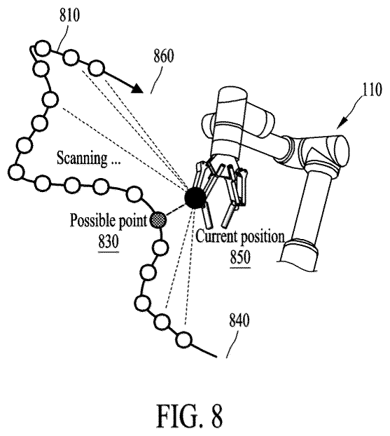

FIG. 8 is a diagram illustrating an operation of determining a progress of a current position, according to an embodiment.

Referring to FIG. 8, an electronic device (e.g., the electronic device 130 of FIG. 1) may predict the progress corresponding to the current position 850 of a robot (e.g., the robot 110 of FIG. 1) using a neural network (e.g., the sampling distribution estimation model 400 of FIG. 4 and/or the progress predictor 401 of FIG. 4), or may predict the progress corresponding to the current position 850 by utilizing a sampling-based moving path planning process (e.g., RRT).

According to an embodiment, the electronic device 130 may, using an RRT algorithm, randomly sample an arbitrary point in a configuration space in which the robot (e.g., the robot 110 of FIG. 1) may perform a task. The electronic device 130 may expand a tree by adding samples, which may be obtained by performing random sampling on the entire configuration space, to the tree until the obtained samples reach a target point 860 from the current position 850. The electronic device 130 may, by expanding the tree, obtain a moving path 810 from the current position 850 of the robot 110 to the target point 860. The electronic device 130 may obtain a plurality of moving paths from the starting point 840 to the target point 860 in the above manner.

According to an embodiment, the electronic device 130 may predict the progress corresponding to the current position 850 by comparing the points included in the moving path 810 obtained through RRT in the configuration space with the current position 850 of the robot 110. For example, the electronic device 130 may identify a possible point 830 closest to the current position 850 among the points included in the moving path 810. The electronic device 130 may calculate the progress corresponding to the possible point 830 on the moving path 810. The progress calculation may be performed using, for example, Equation 1 or a similar equation. The electronic device 130 may determine, as the progress corresponding to the current position 850, the progress corresponding to the possible point 830, which is the closest point to the current position 850 included in the moving path 810. As described above, the progress corresponding to the current position may also be determined by utilizing a sampling-based moving path planning process (e.g., RRT) in addition to the prediction process of predicting using a neural network described with reference to FIGS. 5 and 6.

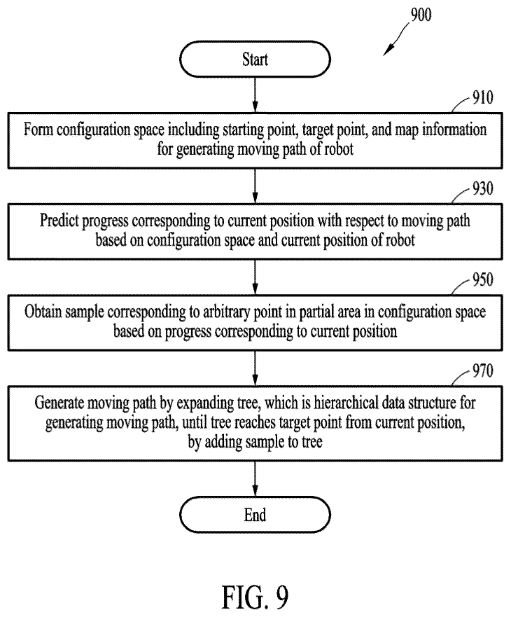

FIG. 9 is a flowchart illustrating a process for planning a moving path of a robot, according to an embodiment.

Referring to FIG. 9, operations 910 to 970 included in a process 900 may be performed sequentially, but embodiments are not limited thereto. For example, the order of operations 910 to 970 may be changed, and at least two of operations 910 to 970 may be performed in parallel.

At operation 910, an electronic device (e.g., the electronic device 130 of FIG. 1) may form a configuration space including a starting point, a target point, and map information to generate a moving path of a robot (e.g., the robot 110 of FIG. 1).

According to an embodiment, the starting point may be a shape formed in the configuration space at a starting position before the robot 110 performs a motion. The starting point may include a starting position and position information of the robot 110 at the starting position.

According to an embodiment, the target point may be a shape formed in the configuration space at a target position toward which the robot 110 may perform a motion. For example, the target position may be a position at which the robot 110 may perform a task, or an operation corresponding to the task. The target point may include the target position and position information of the robot 110 at the target position.

According to an embodiment, the map information may include a grid map. The grid map may correspond to a work environment of the robot 110. For example, the grid map may include a free space and an occupied space, in which each grid location or grid point may have a value between a value of zero (“0”) and a value of one (“1”), and a moving path may be generated.

According to one embodiment, a configuration space may be a dynamic space (e.g., a working environment of the robot 110) in which the robot 110 may perform a task. A starting point and a target point may be formed in the configuration space. In the configuration space, a shape at a starting position before the robot 110 performs a motion may be formed, and a shape at a target position, toward which the robot 110 may perform a motion, and at which the robot may perform the task, may be formed. In addition, elements such as obstacles within the work environment of the robot 110 may be formed in the configuration space.

At operation 930, the electronic device 130 may predict a progress corresponding to the current position with respect to the moving path (e.g., on or along the moving path), based on the configuration space and the current position of the robot 110. The electronic device 130 may predict the progress corresponding to the current position of the robot 110 using a neural network (e.g., the progress predictor 401 of FIG. 4) based on the starting point and the target point included in the configuration space and the current position of the robot 110. However, the electronic device 130 may also determine the progress corresponding to the current position by comparing the point included in the moving path obtained through RRT in the configuration space with the current position of the robot 110.

At operation 950, the electronic device 130 may obtain a sample corresponding to an arbitrary point in a portion of the configuration space (e.g., in a portion of an area or a partial area included in the configuration space) based on the progress corresponding to the current position. The portion of the configuration space may be an area in which a next position is likely to exist (e.g., an area in which a next position is predicted to exist according to the progress) (e.g., an area including a predicted next position). The electronic device 130 may, instead of performing sampling in the entire area in the configuration space, perform sampling in the area in which a next position is predicted to exist (e.g., in the area including the predicted next position) based on the progress. The sample may correspond to the next position of the current position. For example, when the progress corresponding to the current position of the robot 110 is close to 0%, the area in which the next position is likely to exist (e.g., the area including the predicted next position) may be an area oriented toward the starting point rather than the target point (e.g., an area that is closer to the starting point than to the target point).

According to an embodiment, when a constraint in the configuration space is added, the electronic device 130 may sample points that satisfy the constraint to generate the sample. For example, the electronic device 130 may sample, among points included in the area including the predicted next position, the points that satisfy the constraint.

At operation 970, the electronic device 130 may generate the moving path by expanding a tree, which may be a hierarchical data structure for generating the moving path, until the tree reaches the target point from the current position, by adding the sample to the tree. The electronic device 130 may add noise to the obtained sample to obtain a noisy sample, and the electronic device 130 may expand the tree by adding the noisy sample to the tree.

According to an embodiment, the electronic device 130 may configure the tree with the starting point as a root node and the target point as a leaf node. During initial expansion of the tree, the current position of the robot 110 may be the starting point. The electronic device 130 may add noise to the sample obtained at operation 950 to obtain the noisy sample. The electronic device 130 may add the noisy sample to the tree as a next position of the starting point. The electronic device 130 may reset a position corresponding to the sample with the noise added to the current position of the robot 110. The electronic device 130 may re-perform operations 930 and 950 to re-obtain a sample and may expand the tree until the tree reaches the target point by adding the re-obtained sample (e.g., with noise added) to the tree. When the tree reaches the target point, a path connecting all samples from the starting point to the target point may be the moving path of the robot 110.

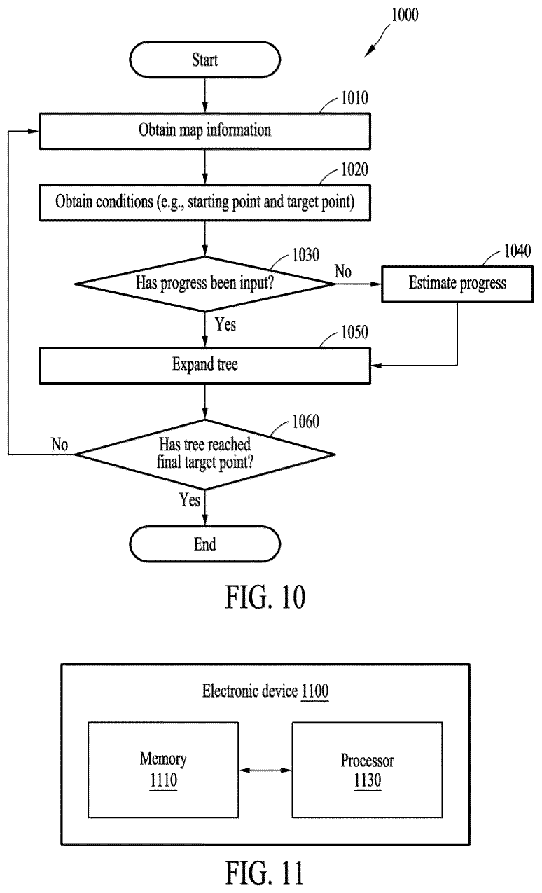

FIG. 10 is a diagram illustrating an operation of planning a moving path of a robot, according to an embodiment.

Referring to FIG. 10, operations 1010 to 1060 included in a process 1000 may be performed sequentially, but embodiments are not limited thereto. For example, the order of operations 1010 to 1060 may be changed, and at least two of operations 1010 to 1060 may be performed in parallel.

At operation 1010, an electronic device (e.g., the electronic device 130 of FIG. 1) may obtain map information. The map information may correspond to a work environment of a robot (e.g., the robot 110 of FIG. 1). In the map information, free space and occupied space within the work environment may be displayed separately.

According to an embodiment, the electronic device 130 may compress the map information using an encoder (e.g., the map encoder 404 of FIG. 4) to reduce a data size of the map information.

At operation 1020, the electronic device 130 may obtain conditions used to generate a moving path of the robot 110. The conditions may include at least one of a starting point and a target point. The conditions may further include constraints. According to embodiments, the constraints may correspond to factors such as obstacles in the work environment, or to other factors such as an overall size of the movement path, a size of each step in the movement path, an overall time corresponding to the movement path, a time corresponding to each step in the movement path, a movement capability of the robot 110, or any other factor, but embodiments are not limited thereto.

At operation 1030, the electronic device 130 may check whether a progress of a current position of the robot 110 has been received. For example, the progress corresponding to the current position of the robot 110 may be input by (e.g., received from) a user. When there is a progress input by a user, the electronic device 130 may immediately perform operation 1050 to generate a moving path. However, when the progress corresponding to the current position of the robot 110 has not been input by the user, the electronic device 130 may perform operation 1040.

At operation 1040, the electronic device 130 may estimate the progress corresponding to the current position of the robot 110. The progress corresponding to the current position of the robot 110 may be predicted by a neural network (e.g., the progress predictor 401 of FIG. 4) or determined using an RRT. An example of a process for predicting the progress by using the progress predictor 401 is described in detail with reference to FIG. 7, and an example of a process for determining the progress using RRT is described in detail with reference to FIG. 8. Thus, a redundant or duplicative description thereof may be omitted.

At operation 1050, the electronic device 130 may expand a tree for generating a moving path of the robot 110. The electronic device 130 may obtain a sample corresponding to a next position by sampling a portion of a configuration space, based on the current position of the robot 110. The electronic device 130 may expand the tree by adding the sample to the tree.

At operation 1060, the electronic device 130 may determine whether the tree has arrived at (or reached) a final target point. As described with reference to operation 1050, the electronic device 130 may add the obtained sample to the tree. For example, when a currently added sample is within a predetermined range with respect to the target point, the electronic device 130 may determine that the tree has arrived at the target point. However, embodiments are not limited thereto, and according to some embodiments, when the currently added sample is within a certain predetermined range with respect to the target point, the electronic device 130 may determine that the tree has not arrived at the target point. When the tree has not arrived at the final target point, the electronic device 130 may repeatedly perform operations 1010 to 1050 by re-performing operation 1010 until the tree arrives at the final target point. When the tree has arrived at the final target point, the electronic device 130 may terminate the process 1000.

FIG. 11 is a diagram illustrating an electronic device according to an embodiment.

Referring to FIG. 11, an electronic device 1100 may include a memory 1110 and a processor 1130. The description provided with reference to FIGS. 1 to 10 may also apply to FIG. 11. For example, at least one of the robot 110, the electronic device 130 of FIG. 1, the training device 200 of FIG. 2B, and the inference device 250 may be, may include, or may be included in, the electronic device 1100.

The memory 1110 may store at least one of a neural network model (e.g., the sampling distribution estimation model 400 of FIG. 4) and parameters of the neural network model. The memory 1110 may store instructions (or programs) executable by the processor 1130. For example, the instructions may include instructions for executing an operation of the processor 1130 and/or an operation of each component of the processor 1130.

The memory 1110 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 1130 may process data stored in the memory 1110. The processor 1130 may execute computer-readable code (for example, software) stored in the memory 1110 and instructions triggered by the processor 1130.

The processor 1130 may be a data processing device implemented as hardware including a circuit having a physical structure to execute desired operations. The desired operations may include, for example, code or instructions in a program.

The hardware-implemented data processing device may include, for example, a microprocessor, a central processing unit (CPU), a processor core, a multi-core processor, a multiprocessor, an ASIC, and an FPGA.

The processor 1130 may cause the electronic device 1100 to perform one or more operations by executing the instructions and/or code stored in the memory 1110. Operations performed by the electronic device 1100 may be substantially the same as the operations performed by the robot 110, the electronic device 130, the training device 200, and/or the inference device 250, described with reference to FIGS. 1 to 11. Accordingly, a redundant or duplicative description thereof may be omitted.

The embodiments described herein may be implemented using hardware components, software components, and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple PEs and/or multiple types of PEs. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The processes according to the above-described embodiments may be recorded in non-transitory computer-readable media including program instructions to implement various operations of the above-described embodiments. The media may also include the program instructions, data files, data structures, and the like alone or in combination. The program instructions recorded on the media may be, or may include, those specially designed and constructed according to embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions may include both machine code, such as those produced by a compiler, and files containing higher-level code that may be executed by the computer using an interpreter.

The above-described hardware devices may be configured to act as one or more software modules in order to perform the operations of the above-described embodiments, or vice versa.

Although some embodiments are described above with reference to the limited number of drawings, it will be apparent to one of ordinary skill in the art that various technical modifications and variations may be made in the embodiments without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. An electronic device comprising:
a processor; and
a memory configured to store instructions which, when executed individually or collectively by the processor, cause the electronic device to:
form a configuration space comprising a starting point, a target point, and map information for generating a moving path of a robot;
predict, based on the configuration space, a current position of the robot, and a progress corresponding to the current position with respect to the moving path;
obtain a sample corresponding to an arbitrary point in a portion the configuration space, based on the progress; and
generate the moving path by expanding a tree until the tree reaches the target point from the current position, by adding the sample to the tree,
wherein the tree represents a hierarchical data structure for generating the moving path.

2. The electronic device of claim 1, wherein the starting point comprises a shape at a starting position in the configuration space before the robot performs a motion.

3. The electronic device of claim 1, wherein the target point comprises a shape at a target position in the configuration space at which the robot performs a task.

4. The electronic device of claim 1, wherein the instructions, when executed individually or collectively by the processor, further cause the electronic device to:
predict the progress using a neural network based on the configuration space and the current position.

5. The electronic device of the claim 1, wherein the tree comprises a rapidly-exploring random tree (RRT), and
wherein the instructions, when executed individually or collectively by the processor, further cause the electronic device to:
determine the progress by comparing the current position with a point included in the moving path.

6. The electronic device of claim 1, wherein the instructions, when executed individually or collectively by the processor, further cause the electronic device to:
determine, based on the progress, an area including a predicted next position is in the configuration space; and
generate the sample by uniformly sampling a point included in the area.

7. The electronic device of claim 1, wherein the instructions, when executed individually or collectively by the processor, further cause the electronic device to:
based on a constraint being added to the configuration space, generate the sample by sampling a point that satisfies the constraint.

8. The electronic device of claim 1, wherein the instructions, when executed individually or collectively by the processor, further cause the electronic device to:
add noise to the sample to obtain a noisy sample; and
add the noisy sample to the tree.

9. An operating method of an electronic device, the operating method comprising:
forming a configuration space comprising a starting point, a target point, and map information for generating a moving path of a robot;
predicting, based on the configuration space a current position of the robot, a progress corresponding to the current position with respect to the moving path;
obtaining a sample corresponding to an arbitrary point in a portion of area in the configuration space, based on the progress; and
generating the moving path by expanding a tree until the tree reaches the target point from the current position, by adding the sample to the tree,
wherein the tree represents a hierarchical data structure for generating the moving path.

10. The operating method of claim 9, wherein the starting point comprises a shape at a starting position in the configuration space before the robot performs a motion.

11. The operating method of claim 9, wherein the target point comprises a shape at a target position in the configuration space at which the robot performs a task.

12. The operating method of claim 9, wherein the predicting of the progress of the current position comprises:
predicting the progress using a neural network based on the configuration space and the current position.

13. The operating method of claim 9, wherein the tree comprises a rapidly-exploring random tree (RRT), and
wherein the predicting of the progress comprises:
determining the progress by comparing the current position with a point included in the moving path.

14. The operating method of claim 9, wherein the obtaining of the sample comprises:
determining, based on the progress, an area including a predicted next position in the configuration space; and
generating the sample by uniformly sampling a point included in the area.

15. The operating method of claim 9, wherein the obtaining of the sample comprises:
based on a constraint being added the configuration space, generating the sample by sampling a point that satisfies the constraint.

16. The operating method of claim 9, wherein the generating of the moving path comprises:
adding noise to the sample to obtain a noisy sample; and
adding the noisy sample to the tree.
